(19) United States
(12) Patent Application Publication
(10) Pub. No.: US 2006/0274200 A1
(43) Pub. Date: Dec. 7, 2006

(54) Decoder and method for decoding bit stream

(75) Inventor: Keiichiro Fujie, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/443,118

(22) Filed: May 31, 2006

(30) Foreign Application Priority Data
May 31, 2005 (JP) 2005-160073

(51) Int. Cl. H04N 5/04

(52) U.S. Cl. 348/500

(57) ABSTRACT

A decoder includes: a decode unit for calculating the number of display fields exclusive of a repeat field from a bit stream generated by performing frame conversion and decoding the bit stream; and a image selection unit for selecting a display image exclusive of the repeat field from among a plurality of images provided by decoding the bit stream and outputting the selected display image as an image signal.

### RELATED APPLICATION(S)

The present disclosure relates to the subject matter contained in Japanese Patent Application No. 2005-160073 filed on May 31, 2005, which is incorporated herein by reference in its entirety.

### FIELD

The present invention relates to a decoder, and in particular to a decoder that decodes an MPEG2 video stream.

### BACKGROUND

A decoder that decodes a motion picture experts group 2 (MPEG2) video stream performs data reducing process when, for example, converting an input NTSC format signal (which will be hereinafter referred to as “NTSC signal”) into a PAL format signal (which will be hereinafter referred to as “PAL signal”) for output, or when performing fast-forward playback. Refer to JP-A-5-323926 for an example of such data reducing process. The “data reducing process” refers to processing of skipping display of a part of data included in a signal input to the decoder.

When a content signal such as the video stream is converted into the NTSC signal, frame conversion such as 3:2 pull-down conversion may be performed to adjust the frame rate difference between the content signal and the NTSC signal. The “3:2 pull-down conversion” refers to a method of generating three-field frame data from two-field frame data. In the 3:2 pull-down conversion, the same video field is output twice from one frame of the video stream, whereby the video stream is converted into NTSC signals. The video field that is output twice will be hereinafter referred to as “repeat field.”

The MPEG2 video stream decoder performs data reducing process of an input bit stream such as the MPEG2 video stream regardless of whether or not the MPEG2 video stream is converted from the NTSC format signal by being subjected to the 3:2 pull-down conversion. Accordingly, in such case, the repeat field that does not degrade the quality of a video even when not displayed is output and displayed; whereas, a video field, other than the repeat field, which degrades the quality when not displayed is thinned out and not displayed.

### SUMMARY

The present invention is directed a video decoder that suppresses image quality degradation of video decoded from a bit stream by performing data reducing process of a repeat field contained in the bit stream with priority assigned to the repeat field.

According to a first aspect of the invention, there is provided a decoder including: a decode unit that calculates a number of display fields exclusive of a repeat field from a bit stream being generated by performing frame conversion, and decodes the bit stream; and an image selection unit that selects a display image exclusive of the repeat field from among a plurality of images provided by decoding the bit stream, and outputs the selected display image as an image signal.

According to a second aspect of the invention, there is provided a decoder including: a decode unit that decodes a plurality of field images from a bit stream being generated by performing frame conversion and including a repeat field; a frame memory that temporary stores the field images decoded by the decode unit; an image selection unit that performs selection of an image to be output in an image signal from among the field images stored in the frame memory; and a control unit that controls the image selection unit to select the image to be output from among the field images except the repeat field.

According to a third aspect of the invention, there is provided a method for decoding a bit stream being generated by performing frame conversion and including a repeat field, the method including: decoding a plurality of field images from the bit stream; temporary storing the decoded field images; performing selection of an image to be output in an image signal from among the stored field images; and controlling the selection to select the image to be output from among the field images except the repeat field.

### BRIEF DESCRIPTION OF THE DRAWINGS

In the accompanying drawings:

FIG. 1 is a block diagram showing a configuration of a decoder according to an embodiment;

FIG. 2 is a schematic drawing showing an example of a content signal to describe a method of 3:2 pull-down conversion;

FIG. 3 is a schematic drawing showing an example of an NTSC signal provided by performing 3:2 pull-down conversion of the content signal in FIG. 2;

FIG. 4 is a flowchart to describe a decoding method according to the embodiment;

FIG. 5 is a schematic drawing showing an example of an NTSC signal to describe the decoding method according to the embodiment;

FIG. 6 is a schematic drawing showing an example of a PAL signal decoded from the NTSC signal in FIG. 5 by the decoding method according to the embodiment; and

FIG. 7 is a flowchart to describe a decoding method according to a modified example of the embodiment.

### DETAILED DESCRIPTION OF THE EMBODIMENT(S)

Referring now to the accompanying drawings, there are shown an embodiment of the invention. In the following description, parts common among embodiments or examples are denoted by the same reference numerals correspondingly, and redundant description will be avoided. Respective diagrams to be referred to are schematic diagrams for explaining the invention and promoting understanding of the invention. For the sake of convenience of illustration in the drawings, there may be differences in shape, size, ratio, etc. from a real apparatus. These differences may be changed on design suitably in consideration of the following description and the known techniques.

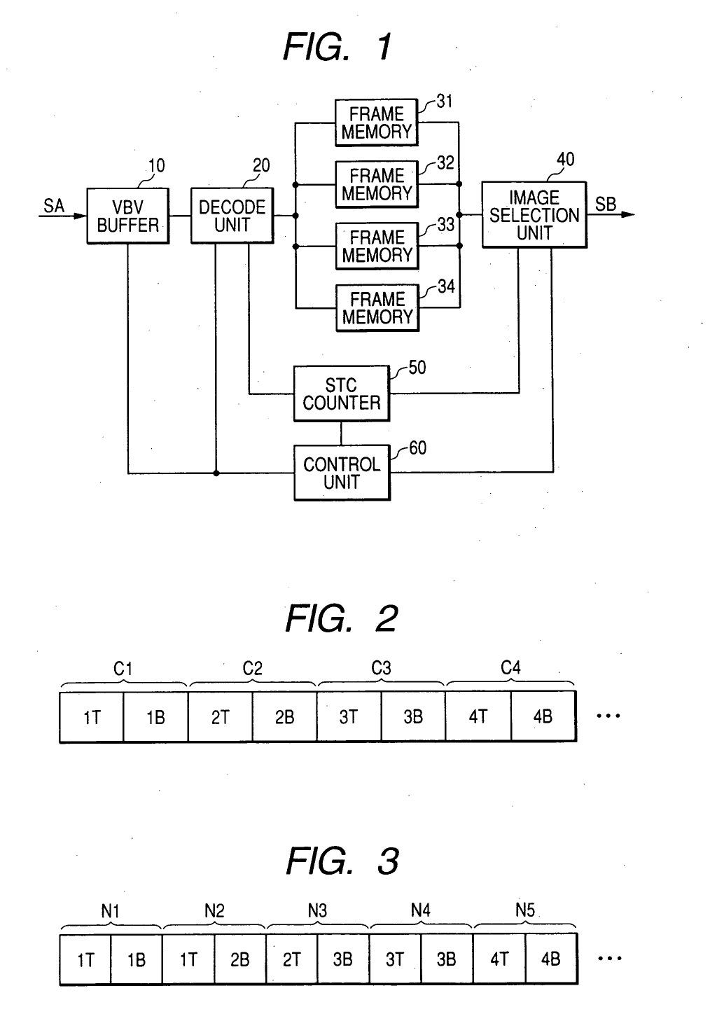

A decoder according to the embodiment includes: a decode unit 20 for calculating the number of display fields exclusive of repeat fields from a bit stream generated by performing frame conversion and decoding the bit stream; and a image selection unit 40 for selecting a display image exclusive of the repeat fields from among a plurality of images provided by decoding the bit stream and outputting the selected display image as an image signal, as shown in FIG. 1. When the decode unit 20 decodes the MPEG2 video stream generated by frame conversion and performs frame rate conversion display or special playback, the decode unit 20 calculates the number of display fields of each picture decoded in units of the number of fields of a display video signal format and at the time, calculates the number of display fields assuming that repeat first field (RFF) and top field first (TFF) indicated in the bit stream are not set, but calculates decoding time stamp (DTS) and presentation time stamp (PTS) used for determining the decode start timing using video signal format, repeat first field (RFF), top field first (TFF) indicated in the bit stream. The image selection unit 40 outputs the image provided by decoding based on the value of the DTS/PTS independently of the repeat first field (RFF) and top field first (TFF).

The decoder shown in FIG. 1 further includes: a VBV buffer 10; frame memory 31-34; an STC counter 50; and a control unit 60. The VBV buffer 10 temporarily stores a bit stream SA input to the decoder. The decode unit 20 is connected to the VBV buffer 10. The decode unit 20 decodes the bit stream SA stored in the VBV buffer 10. The frame memory 31-34 are connected to the decode unit 20. The frame memory 31-34 store each an image provided by decoding of the decode unit 20. Further, the image selection unit 40 is connected to the frame memory 31-34. The image selection unit 40 selects a display image from among the images stored in the frame memory 31-34 to sort the decoded images. The control unit 60 is connected to the VBV buffer 10, the decode unit 20, and the image selection unit 40. The control unit 60 controls the whole decoder. The STC counter 50 is also connected to the decode unit 20, the image selection unit 40, and the control unit 60. The decoder shown in FIG. 1 operates in synchronization with a system time clock (STC) generated by the STC counter 50.

FIG. 1 shows an example that the decoder is provided with four frame memory 31-34. However, the number of the frame memory 31-34 to be provided is not limited to four. An image signal SB output from the decoder is displayed in order on an image display not shown in the figure.

An NTSC signal is a signal an interlace signal of 30 frames a second, namely, 60 fields a second. On the other hand, a content signal of a movie film and the like is a signal of 24 frames a second. Therefore, to convert the content signal into the NTSC signal, data of 24 frames a second needs to be converted into data of 60 fields a second. Thus, when the content signal is converted into the NTSC signal, frame conversion such as 3:2 pull-down conversion is performed. The 3:2 pull-down conversion is a method of adjusting the frame rate difference by generating three fields from a one-frame content signal in the ratio of three frames to two frames.

FIGS. 2 and 3 show an example of the 3:2 pull-down conversion. In this example, consecutive frames C1, C2, C3, C4, . . . of a content signal shown in FIG. 2 are converted into consecutive frames N1, N2, N3, N4, N5, . . . of an NTSC signal shown in FIG. 3. Specifically, the frame C1 is divided into a first field 1T and a second field 1B as shown in FIG. 2. Likewise, the frames C2, C3, C4, . . . are divided into first fields 2T, 3T, 4T, . . . and second fields 2B, 3B, 4B, . . . Three fields are generated from one frame in the ratio of three frames to two frames. To generate three fields from one frame, the third field becomes the same data as the first field. The field thus output twice from one frame of the content signal is the repeat field described above.

For example, the first field 1T and the second field 1B of the frame C1 are combined into the frame N1 of the NTSC signal, as shown in FIG. 3. Further, the first field 1T of the frame C1 and the second field 2B of the frame C2 are combined into the frame N2. This means that three fields of the NTSC signal are generated from the frame C1 using the first field 1T of the frame C1 of the content signal as the repeat signal. The first field 2T of the frame C2 and the second field 3B of the frame C3 are combined into the frame N3 of the NTSC signal. The first field 3T of the frame C3 and the second field 3B of the frame C3 are combined into the frame N4 of the NTSC signal. This means that the second field 3B of the frame C3 is the repeat field. The first field 4T of the frame C4 and the second field 4B of the frame C4 are combined into the frame N5 of the NTSC signal. The NTSC signal is an interlace signal as already described and the suffix “T” of each field of the NTSC signal denotes top field and the suffix “B” denotes bottom field.

As described above, the four-frame content signal is converted into the five-frame NTSC signal by performing the 3:2 pull-down conversion. Finally, the signal of 24 frames a second is converted into data of 60 fields a second.

When a repeat field is generated by performing the 3:2 pull-down conversion, a “repeat first field flag” for specifying output of the repeat flag is contained in the bit stream. In the description to follow, if the repeat first field flag is “1,” it is assumed that the repeat field is next output. For example, if the repeat first field flag is “0,” when the number of display fields is set to two, the number of fields displayed if the repeat first field flag is “1” is set to three. Subsequently, the already output field set to repeat first field flag=1 is redisplayed as the repeat field. A “top field first flag” specifies whether the repeat flag is a top filed or a bottom field. For example, when the top field first flag is “1,” the repeat flag is displayed as the top field.

In the MPEG system standard, bit stream playback time (which will be hereinafter referred to as “time stamp”) information is given to coding units of an audio signal, a video signal, etc. For example, the coding units of the audio signal are audio frames and the coding units of the video signal are pictures. As the time stamp, a presentation time stamp (PTS) for giving the presentation time of the audio signal and the video signal and a decoding time stamp (DTS) for giving the decode start time are defined. However, a time stamp is not given to all bit streams. Thus, the next time stamp is calculated based on the input time stamp. The STC is used as the reference time of the PTS and the DTS.

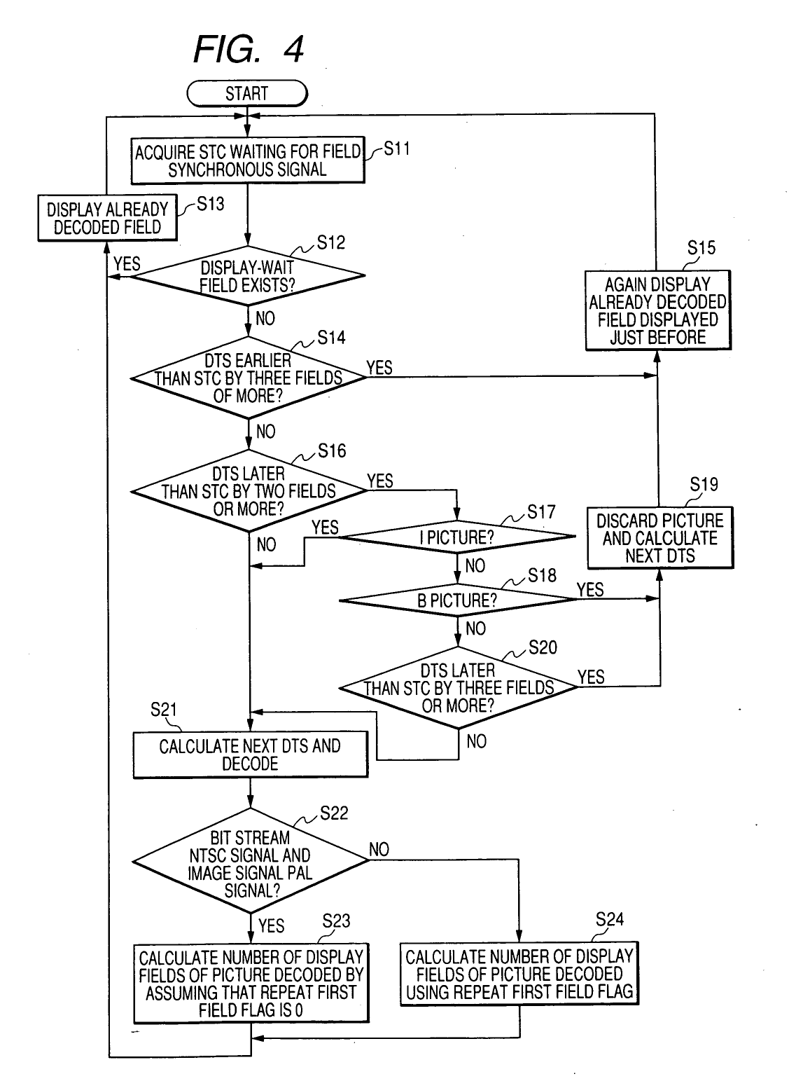

Next, an example of a method of decoding a bit stream SA and outputting an image signal SB by the decoder shown in FIG. 1 will be discussed with a flowchart of FIG. 4. Here, the bit stream SA is an NTSC signal provided by performing 3:2 pull-down conversion and contains repeat fields. The decoder shown in FIG. 1 decodes the bit stream in synchronization with a field synchronous signal that is compliant with the format of an image signal SB. Thus, if the image signal SB is a PAL signal of 50 fields a second, the decode start time is 50 times for one second. On the other hand, the NTSC signal is a signal of 60 fields a second. Therefore, if the image signal SB is a PAL signal, it is necessary to discard NTSC signal fields every 10 fields a second without displaying the fields. The case where the bit stream SA is an NTSC signal and the image signal SB is a PAL signal will be discussed with the flowchart of FIG. 4.

At step S11, the decode unit 20 acquires an STC waiting for a field synchronous signal. At step S12, the control unit 60 determines whether or not a display-wait field exists. The “display-wait field” is an undisplayed field of the same frame as the already displayed field. For example, if the top field of the same frame is displayed preceding the bottom field, the bottom field is the display-wait field. When picture display is started, a display-wait field is always displayed in the next field synchronous signal. Thus, when a display-wait field exists, the process proceeds to step S13 and the image selection unit 40 selects a display-wait field out of the frame memory 31-34 and outputs the selected field as an image signal SB. On the other hand, when a display-wait field does not exist, the process proceeds to step S14.

At step S14, the control unit 60 compares between the DTS giving the decode start time and the STC. When the DTS is earlier than the STC by three display fields or more, for example, the process proceeds to step S15. At step S15, the already decoded field displayed just before is selected by the image selection unit 40. That is, the image selection unit 40 again outputs the image signal SB displayed just before. When the DTS is not earlier than the STC by three display fields or more, the process proceeds to step S16.

At step S16, the control unit 60 compares between the DTS and the STC. When the DTS is later than the STC by two display fields or more, the process proceeds to step S17; otherwise, the process proceeds to step S21.

At step S17, the control unit 60 determines the picture type of bit stream SA. Here, the “picture type” is I picture decoded independently of other pictures, P picture of a signal estimated from the past image, or B picture interpolated from the I picture and the P picture. When the picture type is the I picture, the process proceeds to step S21. When the picture type is the P picture or the B picture, the process proceeds to step S18.

At step S18, the control unit 60 determines the picture type of bit stream SA. When the picture type is the B picture, the process proceeds to step S19 and the B picture is discarded and the decode unit 20 calculates the next DTS and then the process proceeds to step S15. When the picture type is not the B picture, namely, is the P picture, the process proceeds to step S20.

At step S20, the control unit 60 compares between the DTS and the STC. When the DTS is later than the STC by three display fields or more, the process proceeds to step S19 and the P picture is discarded and the decode unit 20 calculates the next DTS and then the process proceeds to step S15. That is, when the DTS is later than the STC by three display fields or more, the B picture and the P picture are discarded until the I picture appears. When the DTS is not later than the STC by three display fields or more, the process proceeds to step S21.

At step S21, the next DTS is calculated and the decode unit 20 decodes the bit stream SA. The image provided by decoding the bit stream SA is stored in the frame memory 31 to 34. Then, the process proceeds to step S22.

At step S22, the control unit 60 determines the formats of the bit stream SA and the image signal SB. When the bit stream SA is an NTSC signal and the image signal SB is a PAL signal, the process proceeds to S23; otherwise, the process proceeds to S24.

At step S23, the number of display fields of the picture decoded by the decode unit 20 is calculated. However, when the repeat first field flag is “1,” the number of display fields is calculated by assuming that the repeat first field flag is “0.” For example, the number of display fields selected by the image selection unit 40 is set to two. Then, the process proceeds to step S13. At step S13, the image selection unit 40 selects as many display images as matched with the number of display fields set except repeat fields from among the images stored in the frame memory 31-34 and outputs the display images as the image signal SB.

On the other hand, at step S24, the number of display fields of the picture decoded is calculated using the repeat first field flag. For example, the number of display fields selected by the image selection unit 40 is set to three. Then, the process proceeds to step S13 and the image selection unit 40 selects as many display images as matched with the number of display fields calculated at step S24 and outputs the display images as the image signal SB. This means that each repeat field is output as the image signal SB.

As described above, at step S23, when the repeat first field flag is “1,” it is assumed that the repeat first field flag is “0.” That is, the repeat first field flag is invalidated, whereby the decode unit 20 calculates the number of display fields exclusive of the repeat field. In the example described above, the number of display fields calculated at step S23 is two.

The image selection unit 40 selects each display image exclusive of the repeat field based on the number of display fields=2. Thus, the repeat field selected if the number of display fields is three is not selected in the decoder shown in FIG. 1. This means that the image selection unit 40 selects each display image exclusive of the repeat field from among the images decoded by the decoding section 20 and outputs the selected display image as the image signal SB.

Specifically, after the number of display fields is calculated as two at step S23, YES is returned at step S12 because the next field synchronous signal contains a display-wait field, and the display-wait field is output as the image signal SB. However, NO is returned at step S12 in the further next field synchronous signal. Except for the case where the DTS is earlier than the STC by three display fields or more, the process proceeds to step S21 via step S16 from step S14. Thus, the repeat field is not output as the image signal SB and the next DTS is calculated and decoding is performed. This means that the repeat field is thinned out and the data is reduced.

In order to convert an NTSC signal into a PAL signal, it is necessary to discard NTSC signal fields every 10 fields a second without displaying the fields. As described above, the repeat field is subjected to data reducing process so as not to display the repeat field, whereby degradation of the image quality of the image signal SB after decode can be decreased. That is, the number of display fields is calculated exclusive of the repeat field from the bit stream SA, whereby the decoder shown in FIG. 1 outputs the image signal SB with the repeat field thinned out. Consequently, discarding of the original image fields of the content signal before 3:2 pull-down conversion is performed can be suppressed to the minimum.

However, the content signal before 3:2 pull-down conversion is performed is a signal of 24 frames a second. On the other hand, the PAL signal is a signal of 50 fields a second. Therefore, it is impossible to thin out all repeat fields for converting the NTSC signal into the PAL signal only with the content signal. When the DTS is earlier than the STC by three display fields or more at step S14 shown in FIG. 4, the process proceeds to step S15. Consequently, the repeat signal is output as the image signal SB. Thus, the PAL signal of 50 fields a second can be output. In the description given above, if the DTS is earlier than the STC by three display fields or more, the process proceeds to step S15 by way of example. However, how many fields the DTS is earlier than the STC by to allow the process to go to step S15 can be set in response to the configuration of the decoder.

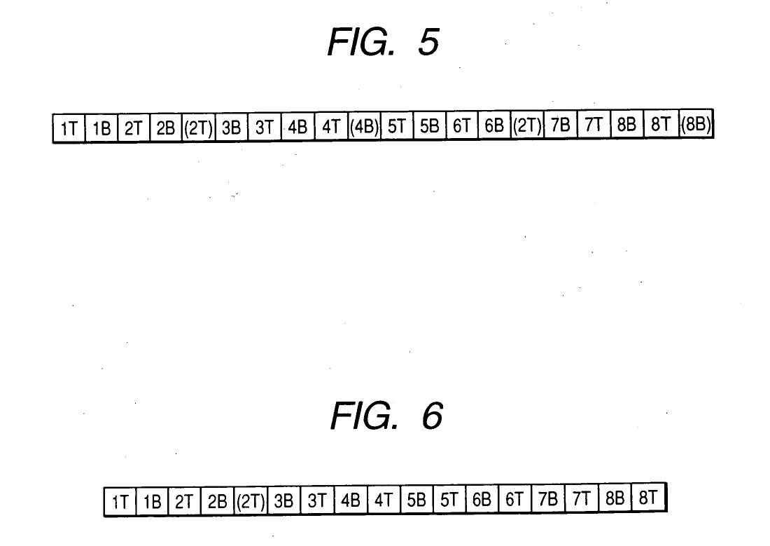

FIGS. 5 and 6 show examples of performing the decoding method shown in FIG. 4. FIG. 5 shows an NTSC signal and FIG. 6 shows a PAL signal provided by decoding the NTSC signal shown in FIG. 5 by the decoding method shown in FIG. 4. The NTSC signal shown in FIG. 5 contains fields 2T, 4B, 6T, and 8B as repeat fields; while, the PAL signal shown in FIG. 6 contains only field 2T as repeat field. In FIGS. 5 and 6, each repeat field is enclosed by parentheses.

When the field structure is disordered as 3:2 pull-down conversion is performed, a state in which the bit stream SA does not contain any repeat field may continue. However, the DTS is calculated using the bit stream SA intact at step S21 in the flowchart of FIG. 4, whereby a transition can be made to data reducing process of interlace video. That is, when the DTS is later than the STC by two display fields or more and the picture type is B picture at steps S16 to S19 in the flowchart, the B picture is discarded. When the DTS is later than the STC by three display fields or more and the picture type is P picture at steps S20 and S19 in the flowchart, the P picture is discarded. That is, when a state in which no repeat field is input continues, the filed not selected by the image selection unit 40 and to be discarded is determined in frame units.

Further, the image selection unit 40 selects the image signal SB to be output based on the picture type of the bit stream SA. First, the B picture having the smallest effect on video if it is discarded is discarded and next the P picture is discarded, as described above. Consequently, if the discarded field is not a repeat field, image quality degradation of video can also be suppressed.

As described above, the decoder according to the embodiment of the invention uses the bit stream SA intact for calculating the DTS, but calculates the number of display fields by assuming that the repeat first field flag is “0.” Consequently, an NTSC signal of 60 fields a second is frame-rate-converted into a PAL signal of 50 fields a second for display. In the frame rate conversion, the repeat field takes precedence over other fields as the field not to be displayed. Further, if a state in which no repeat field is input continues, the NTSC signal is discarded in frame units; frames are discarded in the order of B picture and P picture. Consequently, image quality degradation of video decoded from the NTSC signal subjected to 3:2 pull-down conversion is suppressed and smooth playback video with a small number of discarded frames of content signal can be displayed.

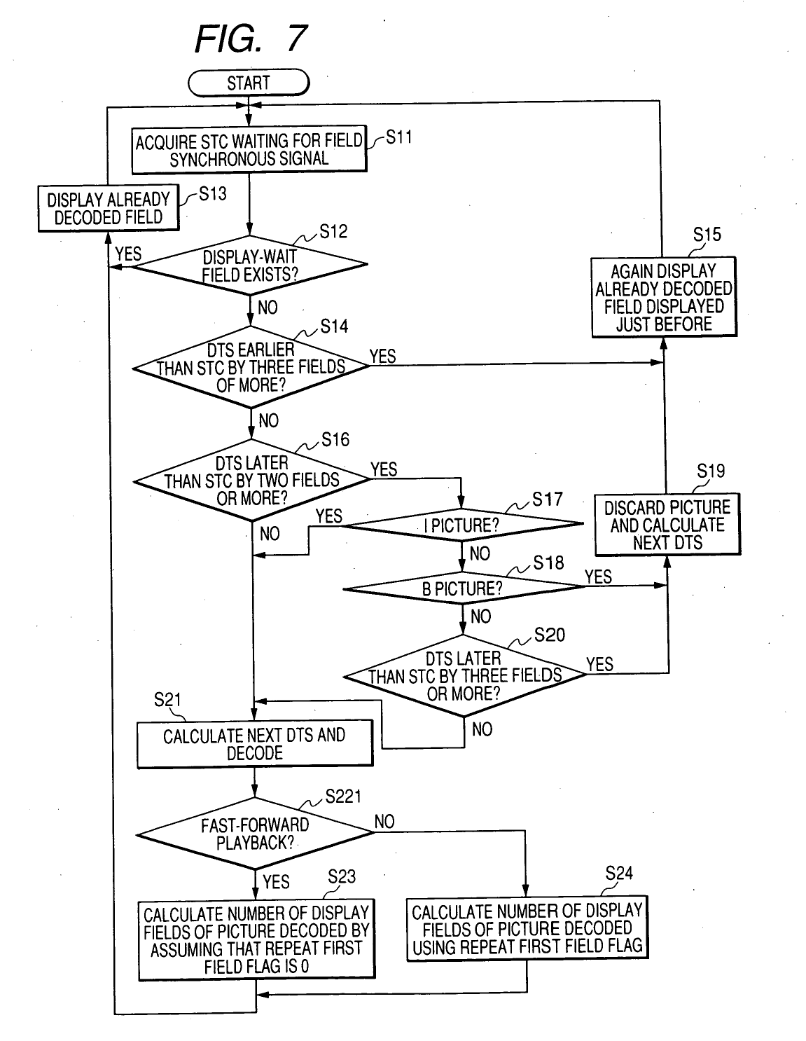

FIG. 7 is a flowchart to describe a decoding method according to a second embodiment, which is a modified example of the first embodiment. The flowchart of FIG. 7 shows a decoding method for outputting an image signal SB as a fast-forward playback image signal of a bit stream SA by performing data reducing process for the bit stream SA. Here, the bit stream SA is NTSC signal subjected to 3:2 pull-down conversion.

The control unit 60 determines the formats of the bit stream SA and the image signal SB at step S22 as previously described with reference to the flowchart of FIG. 4. On the other hand, the control unit 60 determines whether or not fast-forward playback is to be performed at step S221 in the flowchart of FIG. 7. In other points, the flowchart of FIG. 7 is similar to the flowchart of FIG. 4. That is, to perform fast-forward playback, when the repeat first field flag is “1,” the number of display fields of the decoded picture is calculated by assuming that the repeat first field flag is “0” at step S23. On the other hand, not to perform fast-forward playback, the number of display fields is calculated as the repeat first field flag=1 at step S24.

The repeat fields are thinned out for display, whereby the signal contained in the content signal can be displayed without being discarded up to 1.25 times (display with 60 fields/second converted into 48 fields/second) when fast-forward playback is performed. When the decoding method shown in FIG. 7 is adopted for fast-forward playback 1.25 times or more, field data reducing process is performed in addition to thinning out the repeat fields, whereby discarding of the fields of the content signal can be suppressed. Consequently, degradation of the image quality in fast-forward playback can be suppressed.

As described with reference to the embodiments, there is provided a video decoder that can suppress image quality degradation of video decoded from a bit stream by performing data reducing process of a repeat field contained in the bit stream with priority assigned to the repeat field.

The foregoing description of the embodiments has been presented for purposes of illustration and description. It is not intended to be exhaustive or to limit the invention to the precise form disclosed, and modifications and variations are possible in light of the above teachings or may be acquired from practice of the invention. The embodiment is chosen and described in order to explain the principles of the invention and its practical application program to enable one skilled in the art to utilize the invention in various embodiments and with various modifications as are suited to the particular use contemplated. It is intended that the scope of the invention be defined by the claims appended hereto, and their equivalents.

What is claimed is:

1. A decoder comprising:
a decode unit that calculates a number of display fields exclusive of a repeat field from a bit stream being generated by performing frame conversion, and decodes the bit stream; and
an image selection unit that selects a display image exclusive of the repeat field from among a plurality of images provided by decoding the bit stream, and outputs the selected display image as an image signal.

2. The decoder according to claim 1, wherein the decode unit calculates the number of display fields by invalidating a repeat first field flag for specifying output of the repeat field.

3. The decoder according to claim 1, wherein the decode unit decodes the bit stream in synchronization with a synchronous signal that is compliant with a format of the image signal.

4. The decoder according to claim 1, wherein the bit stream is an NTSC format signal and the image signal is a PAL format signal.

5. The decoder according to claim 1, wherein when the bit stream does not contain the repeat field, the image selection unit selects the display image based on a picture type of the bit stream.

6. A decoder comprising:
a decode unit that decodes a plurality of field images from a bit stream being generated by performing frame conversion and including a repeat field;
a frame memory that temporary stores the field images decoded by the decode unit;
an image selection unit that performs selection of an image to be output in an image signal from among the field images stored in the frame memory; and
a control unit that controls the image selection unit to select the image to be output from among the field images except the repeat field.

7. A method for decoding a bit stream being generated by performing frame conversion and including a repeat field, the method comprising:
decoding a plurality of field images from the bit stream;
temporary storing the decoded field images;
performing selection of an image to be output in an image signal from among the stored field images; and
controlling the selection to select the image to be output from among the field images except the repeat field.
